(19) United States
(12) Patent Application Publication
(10) Pub. No.: US 2012/0001406 A1
(43) Pub. Date: Jan. 5, 2012

(54) NON-ELECTRICAL METHODS FOR ILLUMINATION OF AIRBAG EMBLEMS

(76) Inventors: Donald J. Paxton, Romeo, MI (US); Nadeem Bokhari, Troy, MI (US); Raimund Nebel, Obermeitingen (DE)

(21) Appl. No.: 13/148,110

(22) PCT Filed: Feb. 9, 2009
(86) PCT No.: PCT/US09/33514

§ 371 Date: Sep. 27, 2011

(51) Int. Cl. B60R 21/20; B32B 5/16; G09F 3/00; C09K 11/02; B60R 21/16; G09F 13/20

(52) U.S. Cl. 280/728.3; 280/728.1; 40/542; 40/299.01; 252/301.36; 428/323

(57) ABSTRACT

Methods for illuminating (backlighting) an emblem on a steering wheel cover or other indicia within a vehicle include the use of a material that is self-illuminated without electricity. This can involve using self-luminous microspheres or phosphorescent additive materials. Such materials will not be illuminated during the daylight, but when night falls (or other periods of relative darkness), they will illuminate the emblem or other indicia. These materials may be added directly to the plastic that is used to make the emblem.

### BACKGROUND OF THE INVENTION

Airbag systems are commonly used on vehicles and especially in steering wheels. These airbags are designed to inflate during an accident to prevent the occupant from harmful impact with the steering wheel during a crash. Accordingly, the airbag system will generally be positioned in the steering wheel.

It is also known that most vehicle manufacturers want to have their logo or trademark on the steering wheel. These logos or trademarks are often colored images and are positioned on the steering wheel (such as on the cover of the steering wheel that is used to cover the airbag system). Some logos may also have a metallic chrome portion for improved appearance. Such positioning of the logo fosters brand recognition and also helps the vehicle occupant to remember that cars made by the vehicle manufacturer have airbags and are thus safer.

In order to further make the company's logo “stand out,” some parties have even begun to seek for ways to illuminate the logo/trademark. One example of this type of system is found in International Patent Publication No. WO 2007/084031, which document is expressly incorporated herein by this reference.

### BRIEF SUMMARY OF THE INVENTION

The present embodiments relate to ways to illuminate an airbag emblem on an airbag cover that do not involve electrical currents, electricity, etc. Rather, the methods described herein are for self-illuminating airbag emblems. These emblems are generally made of plastic. The plastic will generally be modified to include a self-illuminating material such as a phosphorescent material or self-luminous microspheres. It is this self-illuminating material that “glows in the dark” that provides illumination to the emblem.

In the embodiments involving phosphorescent materials (which are sometimes referred to as phosphorescent additives), the phosphorescent additive absorbs light from the sun or ambient light during daylight hours (i.e., periods of light). Then, at night or when the area is dark (such as in a tunnel, etc.), the phosphorescent material will illuminate and “glow in the dark.” The phosphorescent additives are added directly to the plastic that is used to make the cover and the emblem. The phosphorescent additive may be distributed substantially and evenly throughout the plastic.

For those embodiments that use self-luminous microspheres, the microspheres may be added directly to the plastic materials. For example, the microspheres may compose less than 20% of the total volume of the plastic. Alternatively, the self-luminous microspheres may be added to a paint that is deposited or added onto the emblem. Again, the microspheres will illuminate when it is dark to provide illumination to the emblem. The emblem incorporating the microspheres may also be used in conjunction with a metallic top layer. The metallic layer may (or may not) be translucent, such as a translucent chrome layer or a translucent aluminum layer. This metallic top layer will give the emblem a metallic appearance during daylight hours but will still allow the emblem to have an illuminated appearance (via the illumination provided by the microspheres) during periods of relative darkness (i.e., when there is sufficient absence of light that the emblem will appear to be illuminated).

While many of the present embodiments focus on emblems on steering wheel covers, the present embodiments using self-illumination materials in the plastic could equally be applied to other vehicle features and components. Specifically, if the component is made of plastic, the self-illuminating material could be added to this plastic to allow illumination of such features during nighttime hours. These features include telltales, graphics on passenger airbags, horn bugle graphics on the cover, seatbelt buttons, door handles, turn signals, levers, indicators, instrument buttons, etc. The plastic used to make any of these features could be covered with the translucent metallic layer or be left uncovered as desired.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a cross-sectional view of an airbag cover with an emblem that may be illuminated (backlit) according to the present embodiments, wherein the airbag cover is shown during daylight hours;

FIG. 1B is a cross-sectional view of an airbag cover with an emblem that may be illuminated (backlit) according to the present embodiments, wherein the airbag cover is shown during periods of relative darkness;

FIG. 2 is a perspective view of an airbag emblem according to the present embodiments; and

FIG. 3 is a cross sectional view of the embodiment of FIG. 2 showing how the emblem may be backlit.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

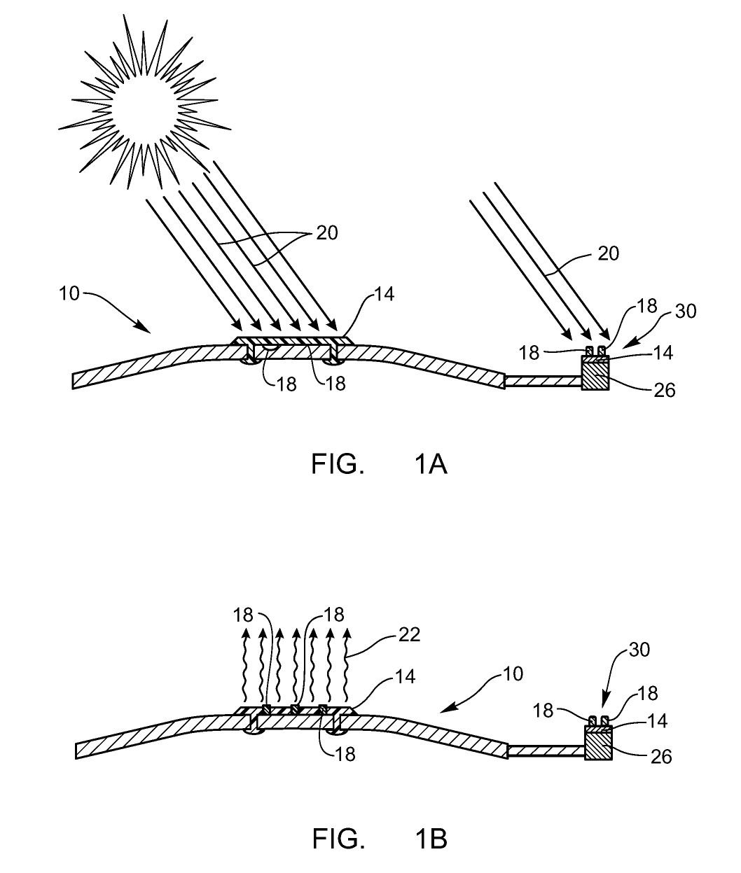

Referring now to FIG. 1A, a cross-sectional view shows an embodiment of a airbag cover 10 that includes an emblem 14. As noted above, the emblem 14 represents the logo or trademark of the vehicle manufacturer. The emblem 14 is made of a plastic material. Those skilled in the art will appreciate how to construct the emblem 14 and how the emblem 14 may be added to the cover 10. For example, the plastic material may be a polycarbonate material or a polycarbonate blend such as polycarbonate plus polyester or polycarbonate plus ABS (Acrylonitrile Butadiene Styrene). Other types of plastics may also be used.

The plastic material used to construct the cover includes one or more phosphorescent additives 18. These additives are added directly to the plastic material. As shown in FIG. 1A, the phosphorescent additives 18 may be distributed equally or substantially throughout the emblem 14. Thus, while the additives 18 are shown in FIG. 1A as being positioned on certain portions of the emblem 14, this depiction is made for illustrative purposes only. Those skilled in the art will appreciate that the phosphorescent additives 18 may be substantially and/or evenly distributed throughout the entire emblem 14.

As shown in FIG. 1A, the phosphorescent additives 18 causes the emblem 14 to absorb light 20 (such as sunlight, ambient light) during daylight or other periods of light. Thus, during daylight hours, the phosphorescent additives may be said to be “charging.” Then, as shown in FIG. 1B, the phosphorescent additives 18 cause the emblem 14 to emit light 22 during period of night or darkness. Thus, the emblem 14, via the phosphorescent additives 18, will “glow in the dark” and be illuminated. Moreover, not only will the emblem 14 be illuminated at nighttime, but also, it will be illuminated (“glow in the dark”) during other periods of darkness, such as when the vehicle passes through a dark tunnel, etc. Some examples of the materials that could be used for the present embodiments include “Makrolon PC Luna” available from Bayer Aktiengesellschaft of Germany. Other materials from this company, as well as other similar materials, may also be used.

The “glow in the dark” element of the present embodiments means that the emblem 14 may be illuminated without any type of electricity or electrical current. Rather, this emblem 14 is a self-illuminated emblem. This provides significant advantages as it can reduce the costs associated with producing the illuminated emblem (as no wiring or illumination costs are incurred). Further, the emblem 14 will not require any light guiding features to get the light from a light source to the emblem, nor is there a requirement for a special design of the emblem. Because no wiring is used in this configuration, there is no chance of defects in the wiring, etc. that would render illumination of the emblem defective. Moreover, the present embodiments, do not affect the deployment of the airbag in any way.

It should also be noted that the present embodiments provide for the possibility of illumination of the emblem 14 with multiple different colors. This may occur by using phosphorescent additives 18 that are different colors when illuminated. Such different phosphorescent additives 18 means that a portion of the emblem 14 would be one color and other portions of the emblem 14 could be a second color, a third color, etc. Those skilled in the art would appreciate how to implement such embodiments.

It is also possible to have illumination in multiple colors by using known 2-K or 3-K molding techniques. Such molding techniques use “multi shot” molds designed to “overmold” within a single molding cycle and is processed on specialized injection molding machines with two or more injection units. Within the mold, pairs of Identical cores and pairs of different cavities are provided. After injection of a first material (for example, a plastic having one color of self-luminous additive) the component is rotated on the core from the one cavity to another. This second cavity differs from the first in that the detail for the second material (for example, a plastic having a different color of self-luminous additive) is included. The second material is then injected into the second cavity detail before the completed part is ejected from the mold. Of course, a skilled artisan using these techniques could mold an emblem that illuminates in two or more colors.

Further embodiments may be constructed in which the emblem 14 is coated so that it has a metallic look (such as with aluminum, chromium, or a PVD (Physical Vapor Deposit) material to provide this metallic “look”). Such embodiments would have a metallic look in the daylight, but an illuminated look during darkness. The coating could operate to hide the illumination during the daylight hours.

It should also be noted that the present embodiments may be added to other types of vehicle apparatus 30. (The airbag cover 10 is a type of a vehicle apparatus). Thus, as shown in FIG. 1A, a plastic telltale 26 may also be made with the phosphorescent additives 18. This telltale 26 could be, for example, a horn symbol, a button, etc. For purposes of this application, the term “indicia” shall include emblems 14 and telltales 26 and any other vehicular component for which self-illumination may be advantageous. The telltale 26 may include the emblem 14. However, in this case, instead of being a logo or trademark emblem 14, the indicia may comprise a symbol that tells the user what the telltale does (i.e., a symbol telling the user that it is a horn, is lettering explaining the buttons function, etc.). Thus, the telltale 26 will be illuminated during periods of darkness due to the phosphorescent additives 18, in the manner described above. In FIG. 1A, the telltale 26 is positioned proximate the edge of the cover 14. However, any position may be used, as desired, within the vehicle interior. Those skilled in the art will appreciate where the telltale 26 may be positioned. In the embodiment shown in FIG. 1A and 1B, an emblem 14 (including the phosphorescent additives 18) is added to the telltale 26. In other embodiments, the phosphorescent additives 18 may be added directly to the telltale 26 without an emblem 14.

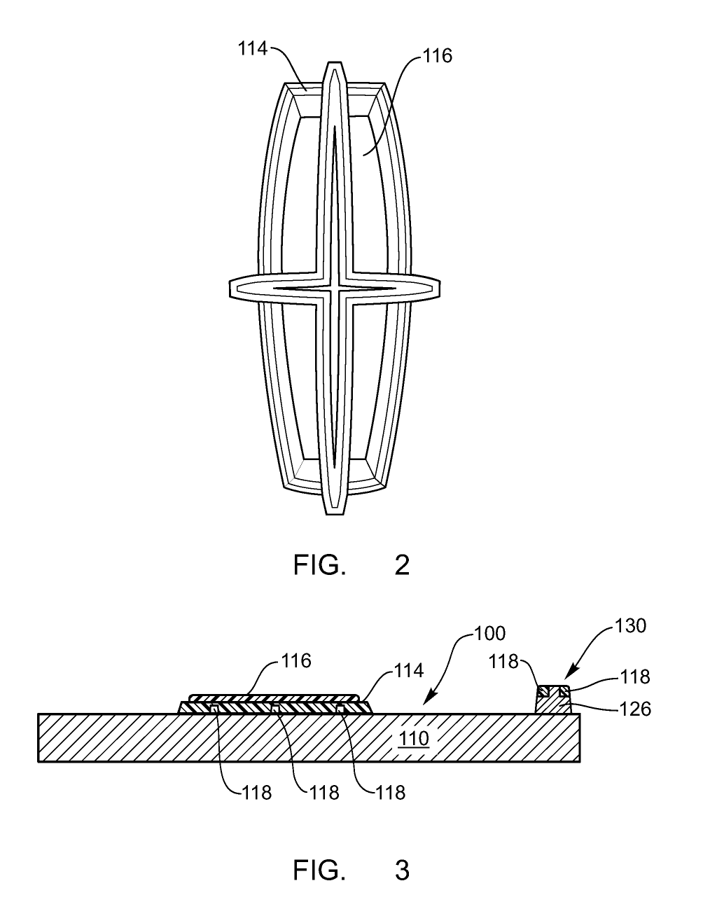

Referring now to FIGS. 2 and 3, another embodiment of the present invention is illustrated. FIG. 2 shows an emblem 114 having a metallic layer 116 such as a chrome-plated surface, while FIG. 3 shows a vehicle component 100 that comprises an airbag cover 110. The cover 110 includes an emblem 114, such as shown in FIG. 2, that includes a metallic layer (chrome-plated surface) 116 that gives the emblem 114 the desired metallic look. The emblem 114 is made of a plastic material that may be covered by the metallic layer 116. The plastic material used to construct the emblem 114 may, like the prior embodiments, be self-illuminating. To this end, the emblem 114 includes self-luminous microspheres 118 that are added to the plastic material used to construct the emblem 114. Examples of such self-luminous microspheres 118 are found in U.S. Pat. No. 4,677,008, which patent is expressly incorporated herein by reference. Again, in FIG. 3, the microspheres 118 are shown in particular areas of the emblem 114. This depiction is made for clarity in the drawing. However, other embodiments may be constructed in which the microspheres 118 are added to the plastic such that the microspheres 118 are distributed substantially and/or evenly throughout the emblem 114. The microspheres 118 provide illumination that is capable of illuminating the emblem 114. It should also be understood that phosphorescent additives (as described above), other than microspheres 118, could also be used to illuminate the emblem. Additionally, phosphorescent additives or microspheres could be added to a paint or other coating that is applied to the emblem 114 to cause it to illuminate as desired.

If a metallic layer 116 is used, the emblem 114 has a metallic appearance during periods of daylight because the metallic layer 116 covers the microspheres 118. Thus, the emblem 114 has a metallic appearance during the day (or periods of light) but has an illuminated appearance during periods of darkness and/or night hours. The metallic layer 116 may operate to hide the illumination of the microspheres 118 during periods of illumination (such as daylight hours) but then allow illumination of the emblem 114 during periods of relative darkness (such as nighttime hours). This is especially true if the metallic layer 116 is a translucent metallic layer such as metallic chrome or aluminum. Thus, during the day, the emblem 114 may not appear to be illuminated. The microspheres may also be available in multiple illuminating colors, thereby giving the manufacturing flexibility and the ability to create a visually appealing design.

The microspheres 118 contemplated and disclosed herein can have a half-life of 12.5 years in their ability to provide illumination which may be superior to other possible sources of illumination for the emblem 114. (This means that after 12.5 years, half of the microspheres 118 will no longer provide illumination). However, the microspheres 118 require no electrical charge to provide the illumination, which greatly reduces the cost of implementation of the illuminated emblem 114 to manufacturers. The microspheres are also very inexpensive and may comprise less than 20% of the total plastic (i.e., less than 20% of the total amount of the plastic material) to provide adequate illumination of the emblem 114. This solution may be significantly less expensive than other illumination sources (i.e., less than $0.05 U.S. dollars as opposed to $8.00 U.S. dollars).

Of course, additional embodiments may be constructed in which the microspheres 118 are not added directly to the plastic during the plastic manufacturing process. Such other embodiments include depositing on the emblem 114 and/or painting the emblem 114 with a paint containing the microspheres 118. The paint may be painted (or otherwise added) to the emblem 114 after the emblem 114 is formed of a non-luminous material.

Again, although the embodiments of FIGS. 2 and 3 show the use of microspheres 118 as part of an airbag cover 114, those skilled in the art will appreciate that this technology could also apply to other vehicle components as well. The same microspheres 118 could be used to illuminate indicia such as graphics on passenger airbags, horn bugle graphics on the cover 114, seatbelt buttons (including seatbelt release buttons), door handles, turn signals, levers, indicators, instrument buttons, etc. The plastic used to make any of these features could be covered with the metallic layer 116 or be left uncovered as desired.

For example, FIG. 3 also shows the use of this technology on a vehicle component 130. This vehicle component 130 is a button 126 in which the plastic used for the button 126 has been modified to include the microspheres 118. The component 130 is positioned on the cover 114. However, those skilled in the art will appreciate other locations where this component may be positioned, as necessary/desired. Thus, using these microspheres, the button 126 will be illuminated.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag apparatus comprising:
an emblem comprising a metallic layer;
self-luminous microspheres that illuminate the emblem.

2. An airbag apparatus as in claim 1 wherein the emblem is made of a plastic material, wherein the self-luminous microspheres are added to the plastic material.

3. An airbag apparatus as in claim 2 wherein the amount of the self-luminous microspheres is less than 20% of the total composition of the plastic.

4. An airbag apparatus as in claim 1 wherein the self-luminous microspheres are added to a paint that has been added to the emblem.

5. An airbag apparatus as in claim 1 wherein the emblem is added to a steering wheel cover.

6. An airbag apparatus as in claim 1 wherein the metallic layer hides the illumination of the self-luminous microspheres during daylight hours.

7. An airbag apparatus as in claim 6 wherein the metallic layer is a translucent chrome layer.

8. A vehicle component comprising a plastic material, the plastic material including a quantity of self-luminous microspheres that illuminate the plastic material during periods of relative darkness.

9. A vehicle component of claim 8 further comprising a translucent metallic layer positioned over the microspheres, the translucent metallic layer hiding the illumination of the self-luminous microspheres during daylight hours.

10. A vehicle component of claim 9 wherein the translucent metallic layer comprises translucent chrome.

11. A vehicle apparatus comprising:
an indicia comprising a plastic material;
one or more phosphorescent additives added to the plastic material, the additives operating to absorb light during periods of daylight and to emit light during periods relative of darkness, wherein the emission of light operates to illuminate the indicia.

12. An apparatus as in claim 11 wherein the indicia is added to an airbag cover.

13. An apparatus as in claim 11 wherein the indicia further comprises a coating on the indicia that gives the indicia a metallic look during the periods of daylight.

14. An apparatus as in claim 13 wherein the coating is a translucent metallic layer.

15. An apparatus as in claim 11 wherein two or more phosphorescent materials are used, thereby giving the indicia a multi-colored appearance when illuminated.

16. An apparatus as in claim 11 wherein the indicia is a telltale.

17. An apparatus as in claim 11 wherein the indicia is an emblem.

18. A vehicle indicia comprising a plastic material, a quantity of self-luminous microspheres or phosphorescent material that is added to the plastic material that illuminates the plastic material without electricity during periods of relative darkness.

19. An indicia as in claim 18 wherein the self-luminous material is added to a paint that is applied to the plastic material.

20. An indicia as in claim 18 wherein the self-luminous material comprises self-luminous microspheres.

21. An indicia as in claim 18 where in the self-luminous material comprises a phosphorescent additive.
